(19) United States
(12) Patent Application Publication
(10) Pub. No.: US 2014/0136313 A1
(43) Pub. Date: May 15, 2014

(54) CATEGORIZING CONTENT SELECTIONS

(71) Applicants: Satyam Shaw, San Jose, CA (US); Christopher Souvey, Santa Cruz, CA (US)

(72) Inventors: Satyam Shaw, San Jose, CA (US); Christopher Souvey, Santa Cruz, CA (US)

(21) Appl. No.: 13/676,403

(22) Filed: Nov. 14, 2012

(51) Int. Cl. G06Q 30/02

(52) U.S. Cl. CPC G06Q 30/0246
USPC 705/14.41

(57) ABSTRACT

An example method includes receiving, from a computing device, a request for a sponsored content item. The method also includes providing the sponsored content item and associated interstitial content for presentation on a user interface. The interstitial content is for presentation after user selection of the sponsored content item. The method includes receiving first interaction data indicative of user selection of the sponsored content item and second interaction data indicative of a navigation input during presentation of the interstitial content. The method also includes, based on the second interaction data, categorizing the user selection indicated by the first interaction data as either an accidental selection or an intentional selection; and taking an action based on the categorizing.

### TECHNICAL FIELD

This disclosure relates generally to categorizing the selection of sponsored content, such as advertisements (“ads”), as accidental or intentional.

### BACKGROUND

The Internet provides access to a wide variety of resources. For example, video, audio, and Web pages are accessible over the Internet. These resources present opportunities for other content (e.g., ads) to be provided along with the resources. For example, a Web page can include slots in which ads can be presented. The slots can be allocated to content providers (e.g., advertisers). An auction can be performed for the right to present advertising in a slot. In the auction, content providers provide bids specifying amounts that the content providers are willing to pay for presentation of their content.

### SUMMARY

In a general aspect, an example method includes receiving, from a computing device, a request for a sponsored content item. The method also includes providing the sponsored content item and associated interstitial content for presentation on a user interface. The interstitial content is for presentation after user selection of the sponsored content item. The method includes receiving first interaction data indicative of user selection of the sponsored content item and second interaction data indicative of a navigation input during presentation of the interstitial content. The method also includes, based on the second interaction data, categorizing the user selection indicated by the first interaction data as either an accidental selection or an intentional selection; and taking an action based on the categorizing.

In another general aspect, one or more example machine-readable storage media store instructions that are executable by one or more processing devices to perform operations including receiving, from a computing device, a request for a sponsored content item and providing the sponsored content item and associated interstitial content for presentation on a user interface. The interstitial content is for presentation after user selection of the sponsored content item. The operations include receiving first interaction data indicative of user selection of the sponsored content item and second interaction data indicative of a navigation input during presentation of the interstitial content. The operations also include, based on the second interaction data, categorizing the user selection indicated by the first interaction data as either an accidental selection or an intentional selection; and taking an action based on the categorizing.

In another general aspect, an example system includes a content management system for receiving a request for a sponsored content item and for providing the sponsored content item and associated interstitial content for presentation on a user interface. The interstitial content is for presentation after user selection of the sponsored content item. The content management system includes a categorization engine for performing operations including receiving first interaction data indicative of user selection of the sponsored content item and second interaction data indicative of a navigation input during presentation of the interstitial content. The operations include, based on the second interaction data, categorizing the user selection indicated by the first interaction data as either an accidental selection or an intentional selection; and taking an action based on the categorizing.

Embodiments may include one or more of the following.

Taking an action includes excluding the user selection from an assessment of a quality of a landing page associated with the sponsored content item.

Taking an action includes excluding the user selection from a determination of an amount to charge for the sponsored content item.

The navigation input includes a cancellation of a loading of a landing page associated with the sponsored content item.

Categorizing the user selection includes categorizing the user selection as an accidental selection.

The second interaction data is indicative of an elapsed time between the user selection of the sponsored content item and a cancellation of a loading of a landing page associated with the sponsored content item.

Categorizing the user selection includes categorizing the user selection as an accidental selection if the elapsed time is less than a threshold time. In some cases, categorizing the user selection includes categorizing the user selection as an intentional selection if the elapsed time is greater than a threshold time.

The interstitial content is for presentation during loading of a landing page associated with the sponsored content item.

Receiving a request includes receiving the request from a mobile device.

The method includes determining the sponsored content item responsive to the request.

The systems and techniques described herein may have a number of advantages. Accidental clicks or taps on content, such as ads, are common, particularly on mobile devices, where the screen size is small. Quality analyses may be complicated by the presence of such accidental ad selections. By excluding accidental ad selections from analyses such as click counts and assessments of landing page quality, the results of those analyses may more accurately reflect the behavior of users who intended to select the sponsored content. The price charged to advertisers may more accurately reflect useful clicks by excluding accidental selections from price determinations.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features, objects, and advantages will be apparent from the description and drawings, and from the claims.

### DESCRIPTION OF DRAWINGS

FIG. 1 is a diagram generally depicting an example process for providing interstitial content.

FIG. 2 is a block diagram of an example network environment.

FIG. 3 is a flowchart of an example process of categorizing a selection of a sponsored content item.

FIG. 4A is a screenshot of an example mobile computing application.

FIG. 4B is a screenshot of an example interstitial content item.

FIG. 4C is a screenshot of an example interstitial content item.

FIG. 5 is a flowchart of an example process of logging user interactions with interstitial content.

Like reference symbols in the various drawings indicate like elements.

### DETAILED DESCRIPTION

Sponsored content items, e.g., ads, are provided with interstitial content in response to a request for content. If a sponsored content item is selected when rendered on a user device, the sponsored content item directs the user device to a particular landing page associated with the content item, e.g., a particular web page designated by an advertiser. While the landing page is loading, the associated interstitial content is presented. User interactions following selection of the sponsored content item are logged and provided to a sponsored content system (e.g., an ad system). In some cases, the user may have accidentally selected a sponsored content item, e.g., by unintentionally clicking or tapping on the sponsored content item, and may cancel the loading of the landing page while the interstitial content is displayed. In these cases, the user selection of the sponsored content item may be categorized as an accidental selection and may be excluded from analyses such as, e.g., an assessment of a quality of the landing page or a determination of an amount of money to charge an advertiser for the sponsored content item.

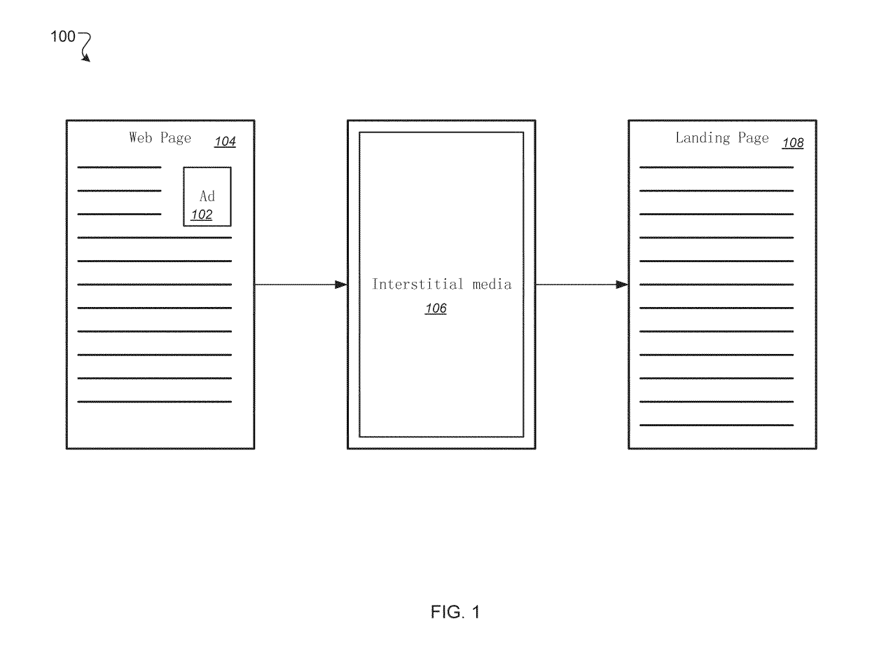

FIG. 1 is a diagram generally depicting an example process 100 for providing interstitial content. A sponsored content item 102 (e.g., an ad) is presented within a container, such as a web page 104 of a browser (in this example) or a mobile application. The web page can include various types of content, such as text, images, audio, and/or video. The ad 102 is associated with a landing page 108 that is requested when the ad is selected (e.g., when a user clicks on or taps the ad 102). When the ad 102 is selected, interstitial content 106 associated with the ad is presented. The interstitial content 106 may be a page displayed in the browser that includes, for example, a loading indicator, additional ad content, advertiser information, a preview of the landing page, or the like. In some instances, the user may have unintentionally selected the ad 102. In some cases, the user can cancel the loading of landing page 108 while the interstitial content 106 is displayed (i.e., before the landing page is displayed), which may cause the user's selection of the ad 102 to be categorized as an accidental selection. The process of FIG. 1 can be implemented in any appropriate network environment.

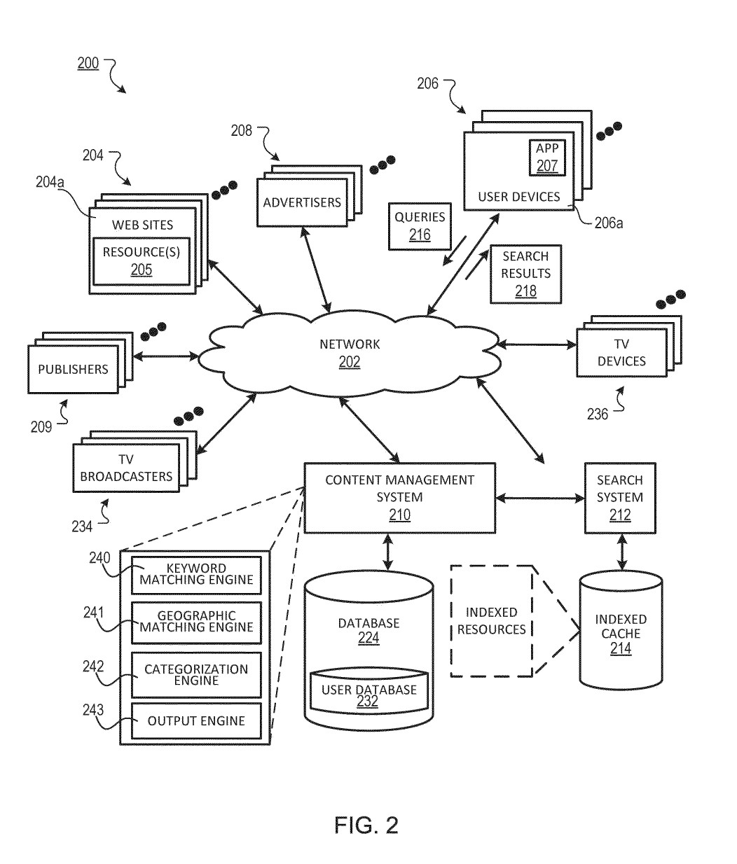

FIG. 2 is a block diagram of an example environment 200 for providing content to a user of a user device in accordance with the example processes described herein for categorizing the selection of sponsored content. The example environment 200 includes a network 202.

Network 202 can represent a communications network that can allow devices, such as a user device 206a, to communicate with entities on the network through a communication interface (not shown), which can include digital signal processing circuitry. Network 202 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth, WiFi, or other such transceiver.

Network 202 connects various entities, such as Web sites 204, user devices 206, content providers (e.g., advertisers 208), online publishers 209, and a content management system 210. In this regard, example environment 200 can include many thousands of Web sites 204, user devices 206, and content providers (e.g., advertisers 208). Entities connected to network 202 include and/or connect through one or more servers. Each such server can be one or more of various forms of servers, such as a Web server, an application server, a proxy server, a network server, or a server farm. Each server can include one or more processing devices, memory, and a storage system.

In FIG. 2, Web sites 204 can include one or more resources 205 associated with a domain name and hosted by one or more servers. An example Web site 204a is a collection of Web pages formatted in hypertext markup language (HTML) that can contain text, images, multimedia content, and programming elements, such as scripts. Each Web site 204 can be maintained by a publisher 209, which is an entity that controls, manages and/or owns the Web site 204.

A resource 205 can be any appropriate data that can be provided over network 202. A resource 205 can be identified by a resource address that is associated with the resource 205. Resources 205 can include HTML pages, word processing documents, portable document format (PDF) documents, images, video, and news feed sources, to name a few. Resources 205 can include content, such as words, phrases, images and sounds, that can include embedded information (such as meta-information hyperlinks) and/or embedded instructions (such as JavaScript scripts).

To facilitate searching of resources 205, environment 200 can include a search system 212 that identifies the resources 205 by crawling and indexing the resources 205 provided by the content publishers on the Web sites 204. Data about the resources 205 can be indexed based on the resource 205 to which the data corresponds. The indexed and, optionally, cached copies of the resources 205 can be stored in an indexed cache 214.

An example user device 206a is an electronic device that is under control of a user and that is capable of requesting and receiving resources over the network 202. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 206a typically stores one or more user applications, such as a Web browser, to facilitate the sending and receiving of data over the network 202. A user device 206a that is mobile (or simply, “mobile device”), such as a smartphone or a table computer, can include an application (“app”) 207 that allows the user to conduct a network (e.g., Web) search. User devices 206 can also be equipped with software to communicate with a GPS system, thereby enabling the GPS system to locate the mobile device.

User device 206a can request resources 205 from a Web site 204a. In turn, data representing the resource 205 can be provided to the user device 206a for presentation by the user device 206a. User devices 206 can also submit search queries 216 to the search system 212 over the network 202. A request for a resource 205 or a search query 216 sent from a user device 206 can include an identifier, such as a cookie, identifying the user of the user device.

In response to a search query 216, the search system 212 can access the indexed cache 214 to identify resources 205 that are relevant to the search query 216. The search system 212 identifies the resources 205 in the form of search results 218 and returns the search results 218 to a user device 206 in search results pages. A search result 218 can include data generated by the search system 212 that identifies a resource 205 that is responsive to a particular search query 216, and includes a link to the resource 205. An example search result 218 can include a Web page title, a snippet of text or a portion of an image obtained from the Web page, and the URL (Unified Resource Location) of the Web page.

Content management system 210 can be used for selecting and providing content in response to requests for content. Content management system 210 also can, with appropriate user permission, update database 224 based on activity of a user. In this regard, with appropriate user permission, the database 224 can store a profile for the user which includes, for example, information about past user activities, such as visits to a place or event, past requests for resources 205, past search queries 216, other requests for content, Web sites visited, or interactions with content. A user can decide whether or not to have information stored in their profile. In some implementations, the information in database 224 can be derived, for example, from one or more of a query log, an advertisement log, or requests for content. The database 224 can include, for each entry, a cookie identifying the user, a timestamp, an IP (Internet Protocol) address associated with a requesting user device 206, a type of usage, and details associated with the usage.

Content management system 210 may include a keyword matching engine 240 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 210 may include a geographic (or “geo-”) matching engine 241 to compare geographic information (e.g., numerical values for place names) obtained from words in input queries to geographic information associated with content.

When a resource 205 or search results 218 are requested by a user device 206, content management system 210 can receive a request for content to be provided with the resource 205 or search results 218. The request for content can include characteristics of one or more “slots” that are defined for the requested resource 205 or search results page. For example, the data representing the resource 205 can include data specifying a portion of the resource 205 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 210. For example, a reference (e.g., URL) to the resource for which the slot is defined, a size of the slot, and/or media types that are available for presentation in the slot can be provided to the content management system 210. Similarly, keywords associated with a requested resource (“resource keywords”) or a search query 216 for which search results are requested can also be provided to the content management system 210 to facilitate identification of content that is relevant to the resource or search query 216.

Based at least in part on data generated from and/or included in the request (e.g., a keyword matching score), the content management system 210 can select content that is eligible to be provided in response to the request (“eligible content items”). For example, eligible content items can include eligible ads having characteristics matching keywords and/or geographic information associated with corresponding content. In some implementations, the universe of eligible content items (e.g., ads) can be narrowed by taking into account other factors, such as previous search queries 216. For example, content items corresponding to historical search activities of the user including, e.g., search keywords used, particular content interacted with, sites visited by the user, etc. can also be used in the selection of eligible content items by the content management system 210.

Content management system 210 can select the eligible content items that are to be provided for presentation in slots of a resource 205 or search results page 218 based, at least in part, on results of an auction, such as a second price auction. For example, for eligible content items, content management system 210 can receive bids from content providers (e.g., advertisers 208) and allocate slots, based at least in part on the received bids (e.g., based on the highest bidders at the conclusion of the auction). The bids are amounts that the content providers are willing to pay for presentation (or selection) of their content with a resource 205 or search results page 218. For example, a bid can specify an amount that a content provider is willing to pay for each 1000 impressions (i.e., presentations) of the content item, referred to as a CPM bid. Alternatively, the bid can specify an amount that the content provider is willing to pay for a selection (i.e., a click-through) of the content item or a conversion following selection of the content item. The selected content item can be determined based on the bids alone, or based on the bids of each bidder being multiplied by one or more factors, such as quality scores derived from content performance, landing page scores, and/or other factors.

As described herein, in some implementations, a content provider can bid for an audience of users. For example, one or more of the publishers 209 and/or the content management system 210 can provide one or more audiences of users where each user in the audience matches one or more criteria, such as matching one or more demographics. An audience of users can be represented, for example, as a user list. User lists or other representations of audiences can be stored, for example, in a user database 232. A bid from a content provider can specify, for example, an amount that the content provider is willing to pay for each 1000 impressions (i.e., presentations) of the content item to a particular audience of users. The content management system 210 can, for example, manage the presentation of the content item to users included in a particular audience and can manage charging of the content provider for the impressions and distributing revenue to the publishers 209 based on the impressions.

In some implementations, TV (Television) broadcasters 234 produce and present television content on TV user devices 236, where the television content can be organized into one or more channels. The TV broadcasters 234 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with particular television content.

Content management system 210 may also include a categorization engine 242. Categorization engine 242 may implement processes to categorize selections of sponsored content as accidental selections or intentional selections. An example of a process that may be performed by categorization engine 242 is described below.

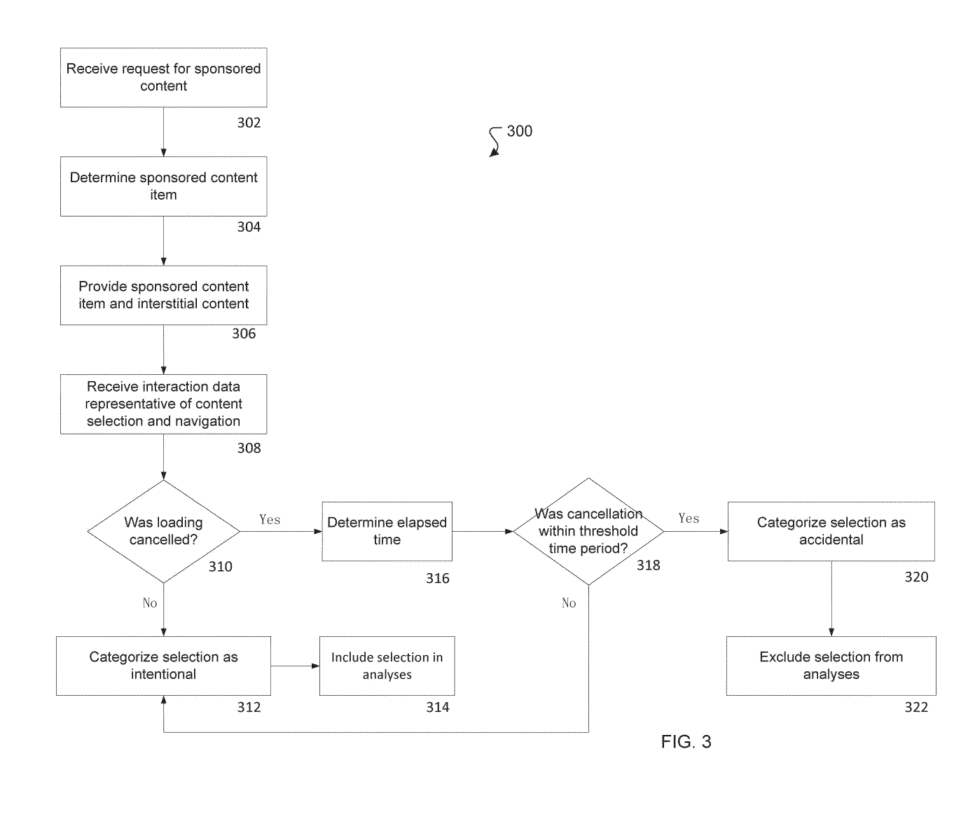

FIG. 3 is a flow chart showing a process 300 for categorizing a selection of a sponsored content item. Process 300 can be performed, e.g., by executable code running in content management system 210 (FIG. 2) in connection with search system 212 or other appropriate application(s). For example, process 300 may be performed, in whole or part, by categorization engine 242. Process 300 is described with respect to online advertising; however, it has applicability to any appropriate online content that is selected for display.

Referring back to FIG. 1, in one example, when an ad is selected (e.g., when a user clicks on or taps an ad), interstitial content associated with the ad is presented, e.g., in a web browser. The user may cancel the loading of a landing page associated with the ad during display of the interstitial content (e.g., if the user did not intend to select the ad). Based on the cancellation, the user selection of the ad may be categorized as an accidental request.

According to a process 300, a request for a sponsored content item (e.g., an ad) is received (302) from a client device, e.g., from a device browser or other application. For example, when displaying a web page, the browser may request one or more sponsored content items from a content management system based on embedded requests in the web page. In some examples, the request is received from a content publisher, e.g., for particular sponsored content to be provided with published content.

A sponsored content item is determined responsive to the request (304). For example, based on the request and other data, the system identifies a particular sponsored content item, from among possible sponsored content items, to return in response to the request. For example, a request can include one or more associated keywords. The keywords can be used to identify a group of candidate sponsored content items (e.g., based on keywords and other data). An auction process can be held among the candidate sponsored content items to determine the sponsored content item to provide for presentation to the user. Other forms of sponsored content selection can alternatively be used.

The sponsored content item and associated interstitial content are provided to the client device (306). The client device can render the received sponsored content item. For example, the client device can render the received sponsored content item in a browser with other content, e.g., with web page content, at a location defined by the web page hypertext markup language (HTML). Alternatively, the client device can render the received sponsored content item within an application, for example, the client device can be a mobile device (e.g., a mobile phone or tablet device) having one or more installed mobile applications.

The interstitial content is content that is not rendered with the sponsored content item (e.g., a graphic or text corresponding to the sponsored content). The interstitial content can be rendered in response to a user interaction, e.g., a user selection, of the presented sponsored content item. The interstitial content is rendered and displayed prior to display of landing page (or other) content requested or a result of the interaction. In some other implementations, the interstitial content includes or is embodied by scripting that is activated in response to a user interaction with the sponsored content item. The scripting can be used to log particular user interactions after the sponsored content item is selected. In some scenarios, the sponsored content item scripting can instruct the client device to present particular interstitial content in response to the user interaction. In some implementations, the scripting can also instruct the client device to retrieve one or more resources associated with a target location identified by the sponsored content item, e.g., a uniform resource locator (URL) for a designated landing page. After the one or more resources are retrieved, they are presented. For example, after landing page content has been retrieved, the landing page is presented in place of any presented interstitial content. In some examples, the loading and presentation of interstitial content may not cause an increase in the load time of the landing page of the corresponding sponsored content item.

The interstitial content may be another sponsored content item, information about a product identified in the sponsored content item, information about the sponsored content provider, or other content. The interstitial content may be an inline loading progress indicator to be superimposed over the web page or application on which the sponsored content item is displayed or superimposed over part of a landing page of the associated sponsored content item. The interstitial content may also be a popup loading progress indicator. The interstitial content may be a preview of some or all of the landing page of the associated sponsored content item. The interstitial content may be an extension of the sponsored content item, such as a map, a site link, or another type of extension. Other types of interstitial content, such as custom content provided by an advertiser, are also possible.

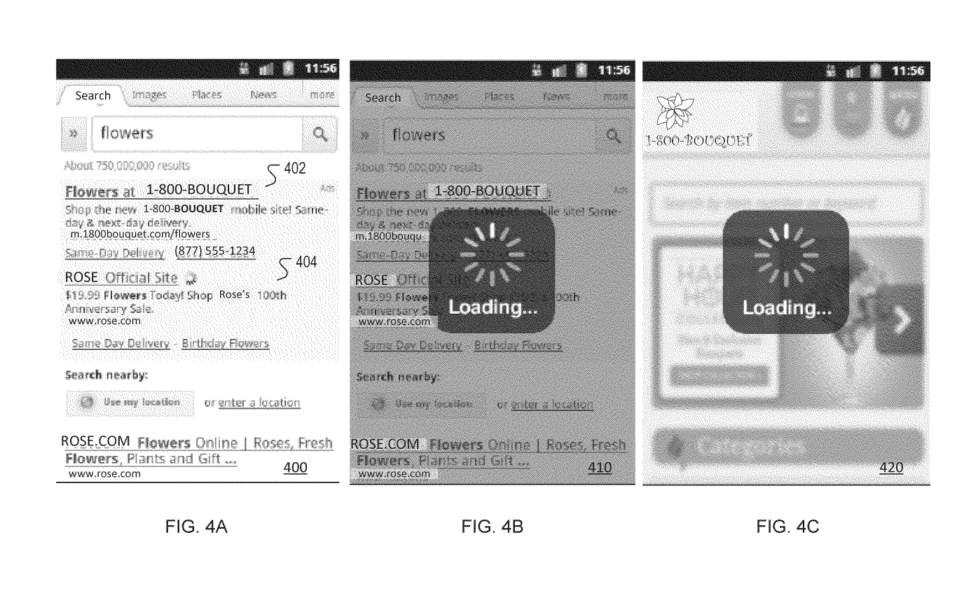

FIG. 4A is a screenshot of an example mobile communication application 400 (e.g., a mobile browser) within which two sponsored content items 402, 404 are displayed. When a user selects one of the sponsored content items (e.g., item 402), associated interstitial content is displayed. FIG. 4B is a screenshot of example interstitial content 410 that includes a loading progress indicator superimposed over the mobile browser in which the sponsored content items are displayed. FIG. 4C is a screenshot of example interstitial content 420 that includes a loading progress indicator superimposed over a portion of a landing page associated with the sponsored content item 402.

Referring back to FIG. 3, the system receives interaction data (308). In particular, the scripting can log the user selection of the sponsored content item (e.g., selection of the sponsored content item via a click or tap) and user interactions associated with the interstitial content. For example, particular user interactions, such as page loads, page un-loads (e.g., cancellation of a page load by selecting a back button in a browser), and rendering start, can trigger scripting events. In general, the user interaction can be a navigation input. For example, the user can abort the current operation (e.g., cancelling the loading of the landing page associated with the sponsored content item while the interstitial content is being displayed). In some implementations, the user can cancel, e.g., by selecting a back button or a stop button, immediately or after some elapsed time. This can be done while the interstitial content is displayed.

The user interaction can also be a selection input within the interstitial content. For example, the user can select content presented by the interstitial content. In some implementations, the user interaction can also include how long the user spends on the landing page after it is retrieved and rendered. The scripting can also log the duration of time for each of one or more interactions, such as the elapsed time between user selection of the sponsored content item and the navigation input (e.g., cancellation of the loading of the associated landing page) or the elapsed time until the landing page is rendered. In some examples, a user can be presented with the rendered landing page and then return back from that page after some elapsed time.

The logged interaction data can be provided to the system by the client device. For example, the logged information can be provided following the user interactions with the interstitial content, as each interaction occurs, or periodically according to a specified schedule or criteria. In some implementations, before the logged user interaction data is provided to the system, the client device can remove individually identifying information in order to anonymize the user. For example, a unique identifier can be used that does not specifically identify the user.

Based on the interaction data, it is determined whether the loading of the landing page associated with the sponsored content item was cancelled (310).

If the loading was not cancelled, the user selection of the sponsored content item is categorized as an intentional selection (312). The selection of the sponsored item (e.g., the click or tap on the link) is included (314) in analyses such as click counts, assessments of a quality of the associated landing page, determinations of an amount of money to charge an advertiser for the sponsored content item, and other analyses.

If the loading was cancelled, an elapsed time between user selection of the sponsored content item and the cancellation of the loading is determined based on the user interaction data (316). If the elapsed time is less than a threshold time (318), such as less than about 10 seconds (e.g., about 10 seconds, about 5 seconds, or about 2 seconds), the selection of the sponsored content item is categorized as an accidental selection (320). The selection of the sponsored item is excluded (322) from analyses such as, e.g., click counts, assessments of a quality of the associated landing page, determinations of an amount of money to charge an advertiser for the sponsored content item, and other analyses. If the elapsed time is greater than the threshold time, the selection of the sponsored content item is categorized as an intentional selection (312). In general, the elapsed time is selected to provide enough time for users who accidentally selected the sponsored content item to respond to the interstitial content by cancelling the loading of the landing page, while avoiding the categorization as accidental of selections by users who intentionally selected a sponsored content item but changed their mind after viewing the interstitial content.

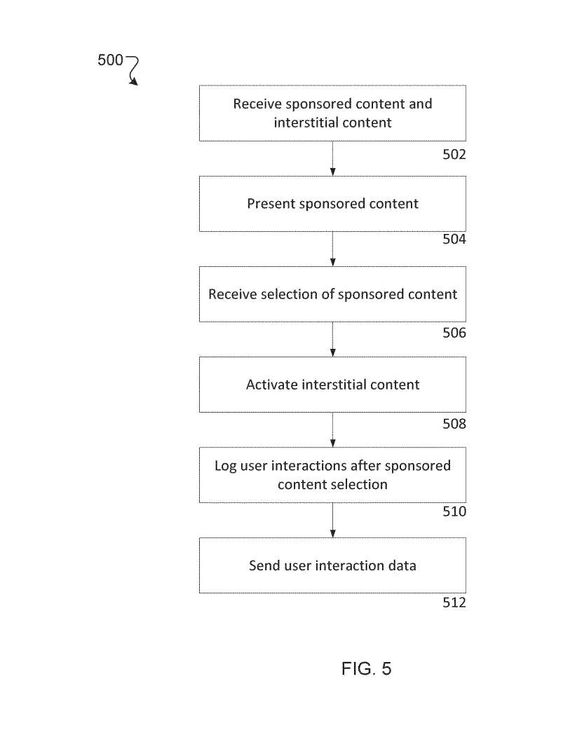

FIG. 5 is a flowchart of an example process 500 of logging user interactions with interstitial content.

A sponsored content item including interstitial content is received (502). The sponsored content item can be received, for example, by a client device in response to a request. The sponsored content item can be received for presentation, for example, within a web page on a browser or within an application e.g., a mobile application. The sponsored content item can include separate interstitial content, e.g., media content, that can be presented, for example, in response to a user selection of the received sponsored content item. In some implementations, the interstitial content is or includes particular scripting included within the sponsored content item and activated in response to a user selection of the sponsored content item.

The received sponsored content item is presented (504). The sponsored content item can be presented within rendered content (e.g., web page content). For example, the sponsored content item can be a sponsored content item to be rendered in web content such as a banner ad on a web page or an ad presented along with search results. The sponsored content item can also be presented with application content. For example, a mobile application can provide various content, e.g., news, games, etc., that can also include one or more sponsored content items.

A user selection of the sponsored content item is received (506). A user input can be provided that selects the sponsored content item using a particular input device. For example, a user can “click” on a sponsored content item using a mouse or trackball device. In some examples, the user device includes a touch sensitive display area and the user can select a sponsored content item by touching the sponsored content item using, e.g., a finger or a stylus.

The interstitial content is activated (508). In some implementations, when the user selects the sponsored content item, a scripting is activated that logs subsequent user interactions associated with the sponsored content item including elapsed time and user inputs. In some implementations, activating interstitial content includes presenting media content to the user. The media content can be an additional sponsored content item or information about the advertiser or landing page. Alternatively, the media content can be a preview of the landing page. In some implementations, the media content requests particular feedback from the user e.g., regarding the selected sponsored content item. The user can interact with the media content to provide the feedback. In some implementations, the media content was received along with the sponsored content item. In some alternative implementations, the media content is requested when the sponsored content item is selected. Additionally, while activating the interstitial content, the landing page is also requested (e.g., based on a URL address encoded with the sponsored content item or as part of the activated scripting). The landing page is presented once it has been retrieved. For example, interstitial media content can be presented until the full landing page has been retrieved.

User interaction after the selection of the sponsored content item is logged (510). The scripting can log user interactions associated with the interstitial content. For example, particular user interaction, such as page loads, page un-loads (e.g., aborting a page load by selecting a back button in a browser), and rendering start, can trigger scripting events.

In general, the user interaction can be a navigation input. For example, the user can abort the current operation (e.g., the request for the associated landing page). In some implementations, the user can abort, e.g., by selecting a back button, immediately or after some elapsed time. The user interaction can also be a selection input within the interstitial content. For example, the user can select content presented by the interstitial content. In some implementations, the user interaction can also include how long the user spends on the landing page once it is retrieved and rendered. The scripting can also log the duration of time for each of one or more interactions including the time until the landing page is rendered. In some implementations, a user can be presented with the rendered landing page and then return back from that page after some elapsed time.

The logged user interaction data is sent to a content management system (e.g., an ad system) (512). For example, data may be logged until a specified stopping point occurs and then send the user interaction data to the system. In some implementations, the stopping point is a particular user interaction (e.g., leaving the landing page or hitting a “back” button that aborts the loading of the landing page). In some implementations, the stopping point is a specific amount of time. For example, to reduce network load, a collection of collected log information can be sent in batches periodically (e.g., daily, weekly). In some implementations, user interaction data can be sent contemporaneously with its occurrence.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to a signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engine described herein can be separated, combined or incorporated into a single or combined engine. The engines depicted in the figures are not intended to limit the systems described herein to the software architectures shown therein.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

All processes described herein and variations thereof (referred to as “the processes”) contain functionality to ensure that party privacy is protected. To this end, the processes may be programmed to confirm that a user's membership in a social networking account is publicly known before recommending a connection to that user through the social networking account. Likewise, the processes may be programmed to confirm that information about a party is publicly known before divulging that information to other party, or even before incorporating that information into a social graph.

In the context of this disclosure, the terms social network and social networking service may be used interchangeably.

In some implementations, the engines described herein can be separated, combined or incorporated into a single or combined engine. The engines depicted in the figures are not intended to limit the systems described here to the software architectures shown in the figures.

Elements of different implementations described herein may be combined to form other implementations not specifically set forth above. Elements may be left out of the processes, computer programs, Web pages, etc. described herein without adversely affecting their operation. In addition, the logic flows depicted in the figures do not require the particular order shown, or sequential order, to achieve desirable results. Various separate elements may be combined into one or more individual elements to perform the functions described herein.

Other implementations not specifically described herein are also within the scope of the following claims.

What is claimed is:

1. A method comprising:
receiving, from a computing device, a request for a sponsored content item;
providing the sponsored content item and associated interstitial content for presentation on a user interface, wherein the interstitial content is for presentation after user selection of the sponsored content item;
receiving first interaction data indicative of user selection of the sponsored content item and second interaction data indicative of a navigation input during presentation of the interstitial content;
based on the second interaction data, categorizing the user selection indicated by the first interaction data as either an accidental selection or an intentional selection; and
taking an action based on the categorizing.

2. The method of claim 1, wherein taking an action comprises excluding the user selection from an assessment of a quality of a landing page associated with the sponsored content item.

3. The method of claim 1, wherein taking an action comprises excluding the user selection from a determination of an amount to charge for the sponsored content item.

4. The method of claim 1, wherein the navigation input comprises a cancellation of a loading of a landing page associated with the sponsored content item.

5. The method of claim 1, wherein categorizing the user selection comprises categorizing the user selection as an accidental selection.

6. The method of claim 1, wherein the second interaction data is indicative of an elapsed time between the user selection of the sponsored content item and a cancellation of a loading of a landing page associated with the sponsored content item.

7. The method of claim 6, wherein categorizing the user selection comprises categorizing the user selection as an accidental selection if the elapsed time is less than a threshold time.

8. The method of claim 6, wherein categorizing the user selection comprises categorizing the user selection as an intentional selection if the elapsed time is greater than a threshold time.

9. The method of claim 1, wherein the interstitial content is for presentation during loading of a landing page associated with the sponsored content item.

10. The method of claim 1, wherein receiving a request comprises receiving the request from a mobile device.

11. The method of claim 1, comprising determining the sponsored content item responsive to the request.

12. One or more machine-readable storage media storing instructions that are executable by one or more processing devices to perform operations comprising:
receiving, from a computing device, a request for a sponsored content item;
providing the sponsored content item and associated interstitial content for presentation on a user interface, wherein the interstitial content is for presentation after user selection of the sponsored content item;
receiving first interaction data indicative of user selection of the sponsored content item and second interaction data indicative of a navigation input during presentation of the interstitial content;
based on the second interaction data, categorizing the user selection indicated by the first interaction data as either an accidental selection or an intentional selection; and
taking an action based on the categorizing.

13. A system comprising:
a content management system for receiving a request for a sponsored content item and for providing the sponsored content item and associated interstitial content for presentation on a user interface, wherein the interstitial content is for presentation after user selection of the sponsored content item,
wherein the content management system comprises:
a categorization engine for performing operations comprising:
receiving first interaction data indicative of user selection of the sponsored content item and second interaction data indicative of a navigation input during presentation of the interstitial content;
based on the second interaction data, categorizing the user selection indicated by the first interaction data as either an accidental selection or an intentional selection; and
taking an action based on the categorizing.
